(19) United States
(12) Patent Application Publication
(10) Pub. No.: US 2001/0034169 A1
(43) Pub. Date: Oct. 25, 2001

(54) Screen element for motor vehicles, in particular, wind blocker

(75) Inventors: Matthias Goetz, Markgroeningen (DE); Joerg Riehle, Stuttgart (DE)

Correspondence Address: LAW OFFICE OF BARRY R LIPSITZ, 755 MAIN STREET, MONROE, CT, 06468, US

(73) Assignee: ORIS Fahrzeugteile Hans Riehle GmbH, Moeglingen (DE)

(21) Appl. No.: 09/804,488

(22) Filed: Mar. 12, 2001

(30) Foreign Application Priority Data
Mar. 13, 2000 (DE) 100 12 166.7

(51) Int. Cl. D03D 15/00; B32B 5/18; B32B 5/24; B32B 3/16; B32B 3/00; D04B 1/00; D04C 1/00; D04G 1/00

(52) U.S. Cl. 442/6; 442/1; 428/56; 428/57; 428/59; 428/192; 428/193; 428/312.8; 428/313.9; 442/9; 442/20

(57) ABSTRACT

In order to improve a screen element for motor vehicles, in particular, a wind blocker or a sun screen, comprising a piece of flat material extending in a surface area such that it can be manufactured more economically, it is proposed that the piece of flat material comprise a woven, knitted or braided fabric consisting of inherently stiff wires or fibers and thus be of inherently rigid construction.

The invention relates to a screen element for motor vehicles, in particular, a wind blocker or a sun screen, comprising a piece of flat material extending in a surface area.

In screen elements known to date for motor vehicles, a flexible material clamped in a frame has been used for the piece of flat material in order, for example, to prevent a wind blocker from fluttering.

However, such a flexible flat material has the disadvantage that it has to be firmly attached to a frame and also has to be clamped therein.

The object underlying the invention is, therefore, to so improve a screen element of the generic kind that it can be manufactured more economically.

This object is accomplished in accordance with the invention with a screen element of the kind described at the outset by the piece of flat material comprising a woven, knitted or braided fabric consisting of inherently stiff wires or fibers and thus being of inherently rigid construction.

The advantage of the solution according to the invention is to be seen in that such a piece of flat material already exhibits such a sufficient inherent rigidity that the stability does not have to be primarily ensured by the frame.

Furthermore, such a piece of flat material has the advantage that the tensioned mounting of the piece of flat material on the frame, which involves high expenditure, can be dispensed with.

Such a piece of flat material for a wind blocker or a sun screen for motor vehicles is preferably produced from a woven, knitted or braided fabric consisting of wires which are so thin that it allows one to see through it, so that, for example, in the case of a wind blocker one can still look through the screen element with the rearview mirror.

Regarding the structure of the wires or fibers, it is, for example, conceivable to use carbon fibers, which are likewise inherently stiff.

Such carbon fibers do, however, have the disadvantage that they do not allow subsequent shaping. For this reason, it is particularly advantageous for the wires or fibers to be produced from a shapeable material, but which is nevertheless inherently stiff, so that it is possible not only to spread out the flat material in a plane but also to give the flat material, for example, a curved shape.

It is, for example, conceivable to also use plastic wires or fibers which, for example, are thermoplastically shapeable.

However, a particularly expedient solution makes provision for the wires to be made of metal, for these, on the one hand, to be shapeable in a simple way by known methods, but, on the other hand, to also exhibit a sufficiently high degree of inherent stiffness.

Since, with the solution according to the invention, the piece of flat material itself has a sufficiently high degree of inherent rigidity, it is, in principle, not necessary to provide a separate frame.

However, to achieve an improved edge rigidity and hence an improved handling of the screen element, provision is preferably made for the wires or fibers in an edge area of the piece of flat material to extend at least partially transversely to the surface area in which the piece of flat material extends.

This results in a particularly simple way in an additional edge stiffening so that the total stability of the screen element does not have to result from the inherent stability of the piece of flat material itself, but rather the edge area extending at least partially transversely to the surface area forms a stabilizing frame around the piece of flat material.

An embodiment of such a screen element makes provision for the wires in the edge area to be shaped so as to form a surrounding edge loop.

A further advantageous embodiment makes provision for the wires in the edge area to be shaped so as to form a bead.

In conjunction with the embodiments explained so far it is assumed that the additionally stabilizing frame is formed from the edge area of the piece of flat material itself.

However, a further advantageous embodiment makes provision for the piece of flat material to have an edge area which has a frame connected thereto.

Such an additional frame has the advantage that it is possible to create in the edge area a closure around the screen element, which is advantageous with respect to appearance and technical safety so that, in particular, there is no necessity for complicated machining of the edge area in order to achieve a closure which is acceptable with respect to appearance and technical safety.

Furthermore, an additional frame has the advantage that it also offers the possibility, in the simple, conventional way, of implementing the holder of the screen element on the motor vehicle with conventional holding elements engaging at the edge.

However, the great advantages of the inherently rigid piece of flat material are nevertheless still present in this embodiment. These are, on the one hand, that the necessity of tensioning the piece of flat material is dispensed with, and, on the other hand, that in addition to its inherent rigidity, the piece of flat material is also adaptable to any surface shapes which differ from a level surface.

Such a frame can be implemented in many different ways. One advantageous embodiment makes provision for the frame to comprise at least one frame part positioned on the edge area.

Such a frame part can be fixed on the edge area in many different ways. It is, for example, conceivable to simply hold the edge area in a positively locking manner on the frame part, for example, by means of a recess provided in the frame part. In the simplest case, the recess can be implemented by two frame parts connectable to each other, with the edge area being inserted into the recess when the frame parts are fitted together.

The frame parts are preferably attached to each other, for example, by an adhesive or welding connection.

A particularly advantageous solution makes provision for the edge area to be embedded in a frame part at least in connecting areas. Such embedding can be achieved by, for example, the frame part being softened in individual frame part elements so as to embed the edge area of the piece of flat material.

Such softening of the frame part can be advantageously carried out in that, in order to create the connecting areas, the frame part made of thermoplastic material is acted upon by ultrasound to heat up and soften the thermoplastic material, so as to thus achieve an embedding of the edge area in the individual connecting areas.

Another advantageous embodiment of the screen element according to the invention makes provision for the frame to be injection molded onto the edge area, i.e., the edge area is placed in an injection mold and injection molding is performed around the edge area.

As an alternative to this, provision is made for the frame to be foamed onto the edge area.

Further features and advantages of the solution according to the invention are the subject matter of the following description and the drawings of several embodiments. The drawings show:

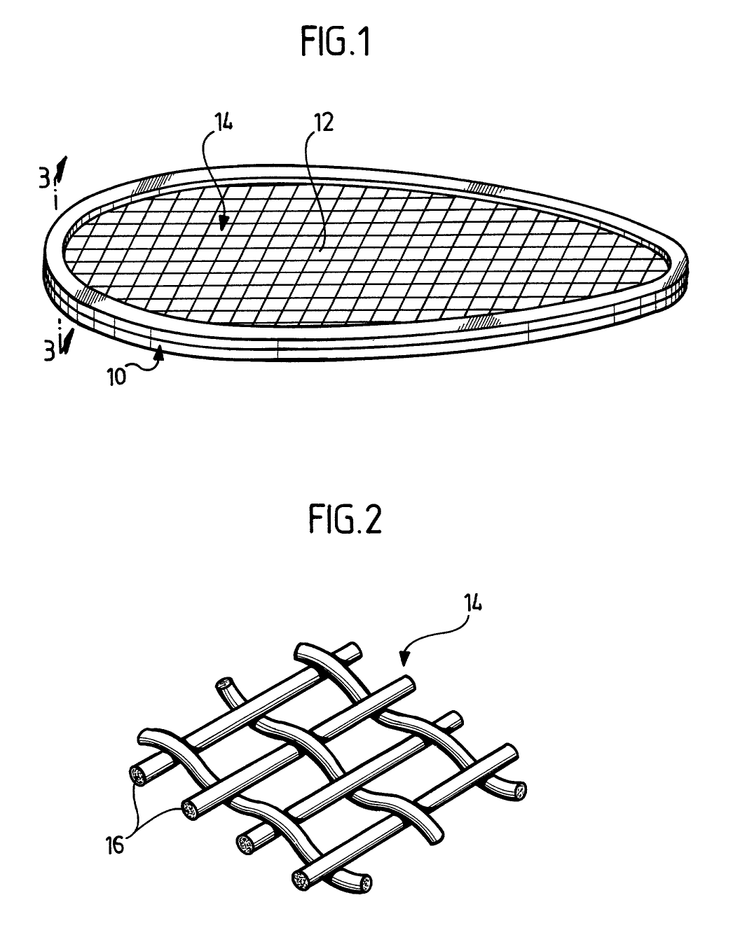

FIG. 1 a perspective illustration of a first embodiment of a screen element according to the invention;

FIG. 2 a partially enlarged illustration of the piece of flat material;

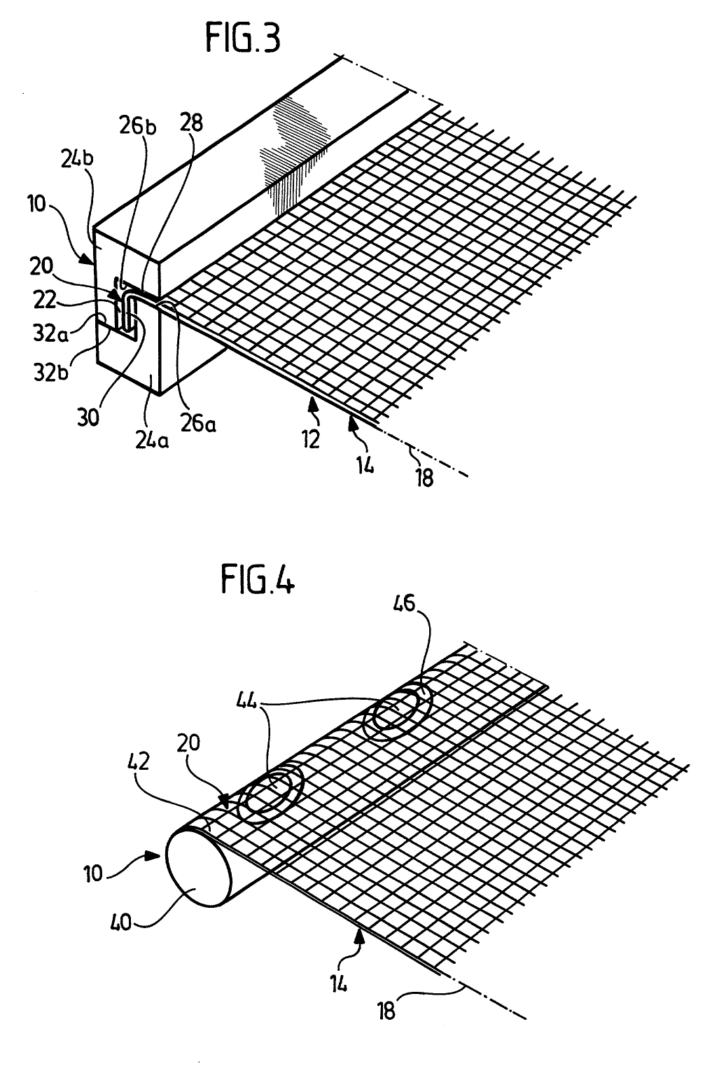

FIG. 3 a perspective section along line 3-3 in FIG. 1;

FIG. 4 a section similar to FIG. 3 through a second embodiment;

FIG. 5 a section similar to FIG. 3 through a third embodiment;

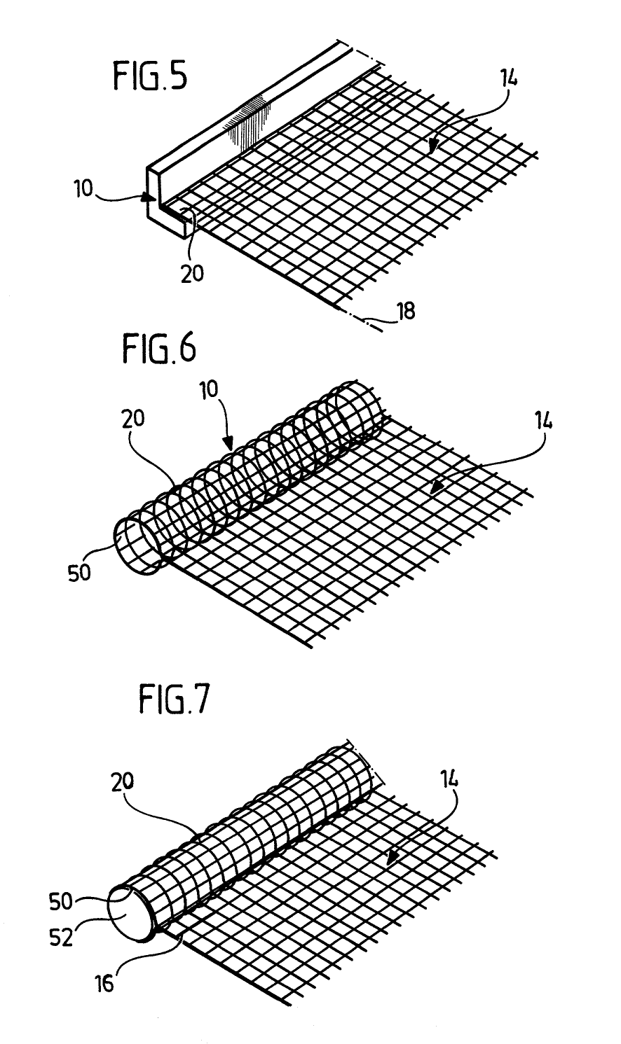

FIG. 6 a section similar to FIG. 3 through a fourth embodiment; and

FIG. 7 a section similar to FIG. 3 through a fifth embodiment.

An embodiment of a screen element according to the invention, shown in FIG. 1, comprises a frame 10 which encloses an area 12 over which a piece of flat material 14 extends.

The piece of flat material 14 is, as shown schematically in FIG. 2, made from a woven or knitted fabric consisting of inherently stiff wires or fibers 16, preferably metal wires, and is, therefore, not flexible, but has an inherent rigidity.

As shown in FIG. 3, in the first embodiment the piece of flat material 14, which extends in a surface area 18 in the area 12 enclosed by the frame, is bent over at an edge area 20 such that the latter extends transversely to the surface area 18. This edge area 20 lies in a recess 22 of the frame 10, which is comprised of two frame parts 24a and 24b, and the recess 22 is provided as free space between these frame parts 24a and 24b for receiving the edge area 20.

The frame parts 24a and 24b each abut with bearing surfaces 26a and 26b on the piece of flat material 14 and fix it in a bearing area 28 of the edge area 20. Starting from this bearing area 28 a bent over area 30 of the edge area 20 extends into the recess 22.

The two frame parts 24a and 24b are preferably provided with further bearing surfaces 32a and 32b, with which they abut directly on one another, and in the area of which a permanent connection between the frame parts 24a and 24b can be made in many different ways.

One possibility for a permanent connection in the area of the bearing surfaces 32a and 32b is that of adhering the frame parts 24a and 24b.

Another possibility is that of joining the frame parts 24a and 24b together in the area of the bearing surfaces 32a and 32b by ultrasonic welding or some other type of welding.

In the case of ultrasonic welding a precondition is that at least one of the frame parts 24a and 24b is made of a thermoplastic material so that at least in individual areas a heating-up and softening of the thermoplastic material can be carried out ultrasonically and the two frame parts 24a and 24b can then be joined to each other due to this softening.

In a second embodiment of a screen element according to the invention, shown in FIG. 4, the piece of flat material 14 is not bent over at the edge area 20, but the edge area 20 extends in continuation of the surface area 18 over a frame part 40 of the frame 10 and rests on a surface 42 of the frame part 40.

If the frame part 40 is provided with energy directing elements 44 lying over the surface 42, it is possible by the application of a sonotrode and the action of ultrasound, if the energy directing elements 44 consist of a thermoplastic material, to heat up and soften the thermoplastic material in the area of the energy directing elements 44 so that a plastic melt is formed, into which the edge area 20 of the piece of flat material 14 is then embedded with the wires 16 so that after solidification of the plastic melt the wires are embedded in a positively locking manner in a material agglomeration 46 formed by softening the energy directing elements 44.

In a third embodiment of the screen element according to the invention, shown in FIG. 5, the dimensional and inherent rigidity of the piece of flat material 14 is put to advantageous use.

In this third embodiment, the edge area 20 of the piece of flat material 14 preferably likewise extends in the direction of the plane 18 and is provided with the frame 10 by the material forming the frame 10 being formed on the edge area 20 by injection molding or foaming it around the edge area 20 so that the edge area 20 is embedded in the material forming the frame 10 and a positively locking connection is thus created between the edge area 20 and the material which is injection molded or foamed around it so as to form the frame 10.

With this solution, if the material forming the frame 10 is a very soft material, the frame 10 can then make only a slight or insignificant contribution to the stability of the screen element so that the stability of the screen element primarily results from the inherent rigidity of the wires 16 of the piece of flat material 14.

In a fourth embodiment, shown in FIG. 6, in order to improve the stiffness of the edge area of the piece of flat material 14, the edge area is shaped by bending over, for example, wrapping over the edge area 20, to form a loop 50 which results in an edge rigidity in addition to the inherent stiffness of the piece of flat material 14.

This bending of the edge area 20 can be protected solely by a simple sheathing or also by injection molding around it. With appropriate machining of the wires 16, it is, however, also conceivable to provide solely the bent over edge area 20 as frame.

In a fifth embodiment, shown in FIG. 7, in a modification of the fourth embodiment, shown in FIG. 6, a piping 52 which contributes towards additional stiffening and stabilization of the edge area is inserted into the bent over edge area 20.

What is claimed is:

1. Screen element for motor vehicles, in particular, wind blocker or sun screen, comprising a piece of flat material (14) extending in a surface area (18), characterized in that the piece of flat material (14) comprises a woven, knitted or braided fabric consisting of inherently stiff wires or fibers (16) and is thus of inherently rigid construction.

2. Screen element as defined in claim 1, characterized in that the wires or fibers (16) are made of a shapeable material.

3. Screen element as defined in claim 1, characterized in that the wires (16) are made of metal.

4. Screen element as defined in claim 2, characterized in that in an edge area (20) of the piece of flat material (14) the wires or fibers (16) extend at least partially transversely to the surface area (18) in which the piece of flat material (14) extends.

5. Screen element as defined in claim 4, characterized in that the wires in the edge area (20) are shaped so as to form a surrounding edge loop (50).

6. Screen element as defined in claim 4, characterized in that the wires (16) in the edge area (20) are shaped so as to form a bead.

7. Screen element as defined in claim 1, characterized in that the piece of flat material (14) comprises an edge area (20) to which a frame (10) is connected.

8. Screen element as defined in claim 7, characterized in that the frame (10) comprises at least one frame part (24a, b; 40) positioned on the edge area (20).

9. Screen element as defined in claim 8, characterized in that the edge area (20) is embedded in a frame part (40) at least in connecting areas (46).

10. Screen element as defined in claim 7, characterized in that the frame (10) is injection molded onto the edge area (20).

11. Screen element as defined in claim 7, characterized in that the frame (10) is foamed onto the edge area (20).
